(19) United States
(12) Patent Application Publication
(10) Pub. No.: US 2024/0378095 A1
(43) Pub. Date: Nov. 14, 2024

(54) AUTOMATIC PROXIMITY DETECTION FOR CONTENT SHARING BETWEEN DEVICES

(71) Applicant: Microsoft Technology Licensing, LLC, Redmond, WA (US)

(72) Inventor: Kyle Thomas KRAL, Duvall, WA (US)

(21) Appl. No.: 18/313,784

(22) Filed: May 8, 2023

(51) Int. Cl. G06F 9/54; H04N 21/45

(52) U.S. Cl. CPC G06F 9/542; H04N 21/4524; G06F 2209/543; H04N 21/43637

(57) ABSTRACT

Systems and methods for automatic proximity detection with content sharing between devices includes a first computing device and a second computing device. The first computing device, in response to a touch point of an input device being at a display edge of a first UI, broadcasts a first beacon, receives a second beacon from a second computing device, the received second beacon including an identification of the second computing device proximate to the display edge of the first UI and a confirmation of a location of the second computing device based on an input being received at the second computing device, generates a connection with the second computing device to transfer the display content, and transfers, via the generated connection, the displayed content to the second computing device. The second computing device presents the transferred content.

### BACKGROUND

Sharing content between devices first requires a connection or pairing between the devices, such as via Bluetooth™. Current technologies are only able to coarsely determine whether devices are proximate to each other, such as within a radius of a few feet.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Systems and methods for automatic proximity detection with content sharing between devices include a first computing device and a second computing device. The first computing device includes a first memory, a first user interface that displays content, a first transceiver, and a first processor coupled to the first memory that, in response to a touch point of a first input being at a display edge of the first user interface (UI), controls the first transceiver to broadcast a first beacon, controls the first transceiver to receive a second beacon from a second computing device, the received second beacon including an identification of the second computing device proximate to the display edge of the first UI and a confirmation of a location of the second computing device based on a second input being received at the second computing device, generates a connection with the second computing device to transfer the display content, and transfers, via the generated connection, the displayed content to the second computing device. The second computing device includes a second memory, a second user interface, and a second transceiver that receives, from the first processor, the broadcasted first beacon, receives the second input indicating the location confirmation, broadcasts the second beacon, receives the displayed content from the first computing device. The second computing device further includes a second processor that presents, on the second UI, the received content at a display edge of the second UI proximate to the display edge of the first UI.

### BRIEF DESCRIPTION OF THE DRAWINGS

The present description will be better understood from the following detailed description read in light of the accompanying drawings, wherein:

FIG. 1 is a block diagram illustrating an example system for automatic proximity detection with content sharing between devices;

FIG. 2 is a block diagram illustrating an example device for automatic proximity detection with content sharing between devices;

FIGS. 3A-3E illustrate a sequence of diagrams for exemplary automatic proximity detection with content sharing between devices;

FIG. 4 is an example flowchart illustrating an example computerized method of automatic proximity detection with content sharing between devices;

FIG. 5 is an example flowchart illustrating an example computerized method of automatic proximity detection with content sharing between devices;

FIGS. 6A-6D illustrate a sequence of block diagrams for exemplary automatic proximity detection with content sharing between devices;

FIG. 7 is an example flowchart illustrating an example computerized method of automatic proximity detection with content sharing between devices;

FIG. 8 is an example flowchart illustrating an example computerized method of automatic proximity detection with content sharing between devices;

FIG. 9 is an example flowchart illustrating an example computerized method of automatic proximity detection with content sharing between devices; and

FIG. 10 is a block diagram of an example computing device for implementing examples of the present disclosure.

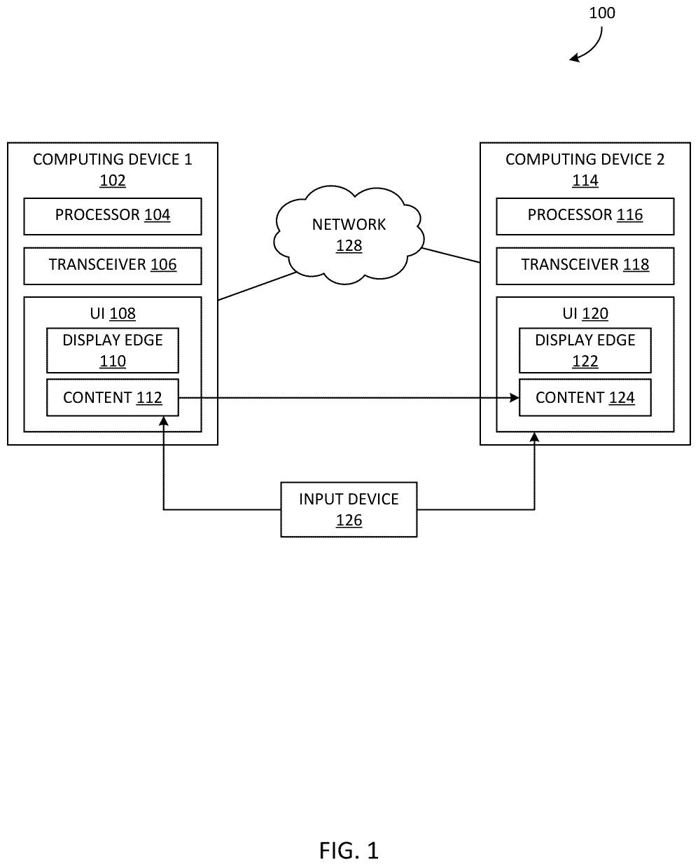

Corresponding reference characters indicate corresponding parts throughout the drawings. In FIGS. 1 to 10, the systems are illustrated as schematic drawings. The drawings may not be to scale. Any of the drawings may be combined into a single embodiment or example.

### DETAILED DESCRIPTION

The various implementations and examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

Conventional techniques for sharing content between devices require a pre-established connection or a manual connection configuration between the devices on each participating device, such as via Bluetooth™. Devices within a coarse radius, such as a few feet, may be detected. However, approximating within a few feet is insufficient for fine-grained proximity detection, such as identifying a location of a device within inches, that enables seamless, pinpoint accuracy for transferring content from one device to another.

Current solutions typically rely on a single signal type to detect proximity between devices, and also require user intervention to establish a connection and then user intervention again to initiate a content transfer. Examples of user intervention involve the user initiating and executing a pairing process that involves multiple steps or traversing a menu, or selecting a particular device from an enumeration of devices that are detected nearby. Further, content sharing between devices relies on each device having a same identity, such as a type of device or registration to a single user or specified group of users, each device being connected to the same network, or the implementation of an intermediate, neutral, shared location such as a universal serial bus (USB) drive.

In contrast, aspects of the disclosure provide systems and methods for improved, automatic proximity detection between devices that enables content sharing between the devices, and removes the need for pre-established pairing between the devices. The example systems and methods described herein leverage multi-signal aggregation that automatically identifies the device a user is interacting with, determines an approximate proximity of the identified device, and transfers content to the identified device.

The systems and methods provided in the present disclosure provide a technical solution and operate in an unconventional manner at least by utilizing multiple signals to pinpoint a location of the target device relative to the initial device and transfer content from the initial device to the target device at the pinpointed location. The multiple signals include an approximate proximity signal sent and received between an initial device and a target device, and a direct contact signal received on the target device. This eliminates the need for manual pairing and/or an intermediate, neutral shared location accessible by both devices. As a result, the systems and methods provided in the present disclosure provide various technical effects, including but not limited to, improvements in user interactions (e.g., human machine interface) between the initial device and target device at least by improving usability through reduced pairing requirements, reduced computation processing load (and hence increased processing speed) by requiring fewer processing steps, and improving process security by removing the need for devices to first be connected to a same network for a content transfer.

FIG. 1 is a block diagram illustrating a system for automatic proximity detection with content sharing between devices according to an example. The system 100 illustrated in FIG. 1 is provided for illustration only. Other examples of the system 100 can be used without departing from the scope of the present disclosure.

The system 100 includes a first computing device 102 and a second computing device 114. Each of the first computing device 102 and the second computing device 114 may be communicatively coupled to and communicate via a network, such as a network 128. Each of the first computing device 102 and the second computing device 114 represent any device executing computer-executable instructions (e.g., as application programs, operating system functionality, or both) to implement the operations and functionality associated with the first computing device 102 and the second computing device 114, respectively. Each of the first computing device 102 and the second computing device 114, in some examples, include a mobile computing device or any other portable device. A mobile computing device includes, for example but without limitation, a mobile telephone, laptop, tablet, computing pad, netbook, gaming device, wearable device, Internet of Things (IoT) device, and/or portable media player. Each of the first computing device 102 and the second computing device 114 can also include less-portable devices such as servers, desktop personal computers, kiosks, IoT devices, or tabletop devices. Additionally, each of the first computing device 102 and the second computing device 114 can represent a group of processing units or other computing devices.

The first computing device 102 includes a processor 104, a transceiver 106, and a user interface (UI) 108. The UI 108 further includes at least one display edge 110 and is operable to present content 112. The content 112 represents any type of content presented on a UI 108, including but not limited to an image, a video, a file, text, an application, and so forth. Similarly, the second computing device 114 includes a processor 116, a transceiver 118, and a UI 120.

The UI 120 further includes at least one display edge 122 and is operable to present content 124. The content 124 represents any type of content presented on a UI 120, including but not limited to an image, a video, a file, text, an application, and so forth. In some examples, the content 124 is an example of the content 112 content transferred from the first computing device 102. In other words, the content 124 is content 112 that was initially presented on the UI 108 as the content 112 and then transferred to the second computing device 114 and presented on the UI 120 as the content 124.

The system 100 further includes an input device 126. In various examples, the input device 126 represents any type of device, extension, or part of a user operable to provide an input to the first computing device 102 and/or the second computing device 114, including but not limited to a stylus, a finger of a user, a camera that tracks the eye of user, a keyboard, a mouse, a joystick, a microphone, and so forth. In some examples, the input to the first computing device 102 and/or the second computing device 114 may be provided via voice command by the user.

The first computing device 102 presents the content 112 within boundaries of the UI 108 that include the display edge 110. In other words, the display edge 110 is a boundary of the UI 108 within which content, including the content 112, may be presented and outside of which content, including the content 112, is not presented. In some examples, the content 112 presented on the UI 108 is operable to be moved about the UI 108. In other words, content 112 is moved from one location on the UI 108 to another location on the UI 108, such as in response to the UI 108 receiving an input from the input device 126.

The UI 108 receives an input from the input device 126 at a touch point. As referenced herein, the touch point is a location on the UI 108 at which the input from the input device 126 is received. In some examples, the touch point is defined by (x, y) coordinates on the UI 108. In some examples, the touch point is defined by a particular pixel, having a predetermined and known location on the UI 108, that receives the input. In some examples, the touch point includes a plurality of touch points, i.e., including, but not limited to, at least two touch points. For example, where the input is a drop-and-drag operation, the touch point includes a first touch point to select the presented content 112 at a first location on the UI 108 and, upon the content 112 being dragged to a new location on the UI 108, a second touch point to release the presented content 112 at the new location on the UI 108.

In some examples, the touch point is received at or approaching the display edge 110 of the UI 108. For example, the touch point is received or identified at a predetermined distance from the display edge 110, at one of a number of pixels identified as proximate to the display edge 110, within a band or area of pixels near the display edge 110, and so forth. As referenced herein, the display edge 110 is defined as pixel boundary of the display. For example, a minimum pixel value of the display is one display edge, while a maximum pixel value is another display edge. In some examples, minimum and maximum pixel values define display edges in both horizontal, between zero and the full screen width, and vertical, between zero and the full screen height, ranges. In other examples, the display edge 110 may also be identified based on a trajectory of a moving touch point calculated to intersect with the display edge 110 (e.g., a pen, stylus, or finger dragging or flicking content towards the display edge 110). In response to the touch point being received at or approaching the display edge 110, the transceiver 106 broadcasts a near-field signal, including but not limited to a Bluetooth™ Low Energy (BLE) beacon. In some examples, the BLE beacon is a Generic ATTribute Profile (GATT) beacon. Other types of near-field signals, such as near-field communication (NFC) and so forth, may be used without departing from the scope of the present disclosure. The beacon is transmitted to identify the presence of another device, such as the second computing device 114, in proximity of the first computing device 102. The beacon is received by any device within the proximity of the first computing device 102, including, in some examples, the second computing device 114. In some examples, the broadcasted beacon is referred to as a BLE announcement, a BLE advertising packet, or a BLE advertisement. The broadcasted beacon includes device and/or content information related to the first computing device 102 and/or the content 112, respectively, including but not limited to a type of device of the first computing device 102, an ID of the first computing device 102, a size of the content 112, a position of the content 112 on the UI 108, an ID of the content 112, a type of content 112, a thumbnail of the content 112, and a uniform resource identifier (URI) of the content 112. In some examples, the broadcasted beacon further includes an input device attribution indicating an ID of the input device 312 from which the input is received, resulting in the beacon being broadcast. As described herein, the position of the content 112 includes (x, y) coordinates of the content 112 on the UI 108, and the type of content 112 includes a description of the content 112 including an application type, a file type, and so forth.

In examples where the second computing device 114 is in proximity of the first computing device 102, i.e., within a range to detect the broadcasted beacon, the transceiver 118 of the second computing device 114 receives the broadcasted beacon. Reception of the broadcasted beacon includes the reception of the device and content information related to the first computing device 102 and the content 112. The UI 120 receives a second input (e.g., from the input device 126) confirming a location of the second computing device 114. Upon receiving the second input, the processor 116 associates, or correlates, the received beacon broadcasted from the first computing device 102 with the received second input. In some examples, associating the received beacon with the received second input includes determining the second input is received within a predetermined time period from receiving the broadcasted beacon and/or attributing the input received with an ID of the input device 126. For example, the input device 126 includes a unique ID associated with it. The broadcasted beacon emits a property containing the unique ID associated with the input device 126 that started the interaction. Upon the second computing device 114 receiving the broadcasted beacon, the second computing device 114 reads the property which has the unique ID. The input device 126 then also contacts the second computing device 114 and a digitizer on the second computing device 114 identifies the input device 126 input on the display itself. The input device 126 is identified using the same unique ID and the second computing device 114 correlates the interaction using the beacon payload with the unique ID of the input device 126 and the digitizer interaction with that same unique ID. Based on the received beacon being associated with the received second input, the transceiver 118 transmits a second beacon, such as a BLE beacon, acknowledging the presence of the first computing device 102 and indicating the second computing device 114 is in a receiving state to receive the content 112 from the first computing device 102.

In some examples, to receive the content 112, the processor 116 computes a y-coordinate at which the content 112 is to be presented on the UI 120 as content 124. For example, the received beacon includes a y-coordinate, also referred to herein as a first y-coordinate, of the display edge 110 at which the content 112 is identified. The processor 116 computes another y-coordinate, also referred to herein as a second y-coordinate, of the display edge 122 of the UI 120 based on first y-coordinate according to a position and orientation of the second computing device 114 relative to the first computing device 102. In other examples, the processor 104 computes the y-coordinate at which the content 112 is to be presented on the UI 120 as content 124 based on position and orientation of the second computing device 114 data included in the broadcasted second beacon.

The orientation and position of the second computing device 114 relative to the first computing device 102 is computed by extrapolating the location of the second input from the touch point of the first input received at the first computing device 102. In particular, a line is computed between an exit coordinate from the first computing device 102 and an entrance coordinate of the second computing device 114. As described herein, an exit coordinate is a coordinate, such as a y-coordinate, value of the display edge 110 at which the content 112 is presented at a time the content 112 is removed from the UI 108, and an entrance coordinate is a coordinate, such as a y-coordinate, value of the display edge 122 at which the content 124 enters the UI 120. The computed line will intersect with a display edge of the first computing device 102 and a display edge of the second computing device 114. The display edges are established as parallel to one another, assuming the interaction takes place as a line. The display edges, once established as parallel, determine the relative orientation of each computing device to each other. In another example, where the first input is a drag-and-drop operation and includes first and second touch points, the second input received at the second computing device 114 provides a third touch point. One of the processor 104 or the processor 116 computes an average of the first, second, and third touch points to generate a y-coordinate of the display edge 122 on the UI 120 at which the content 124 is to be presented. In another example, the processor 104 or the processor 116 computes a trajectory using the first, second, and third touch points to generate a y-coordinate of the display edge 122 on the UI 120 at which the content 124 is to be presented. The processor 116 then presents the content 124 on the UI 120 at the computed y-coordinate.

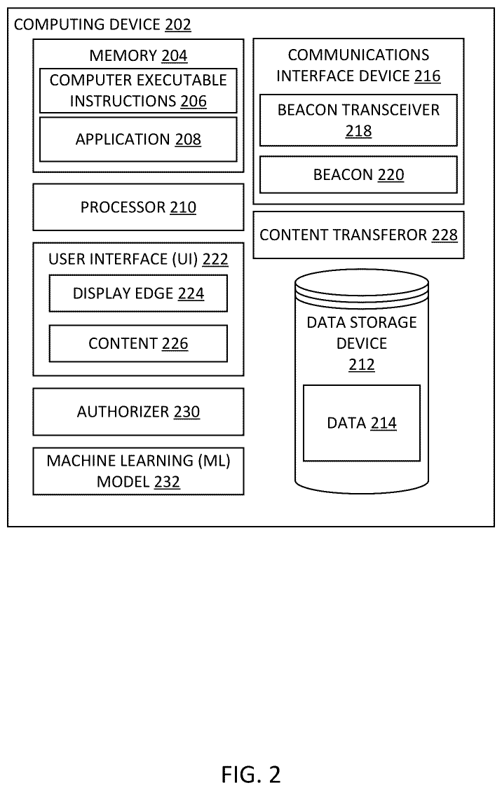

FIG. 2 is a block diagram illustrating a device for automatic proximity detection with content sharing between devices according to an example. The computing device 202 illustrated in FIG. 2 is provided for illustration only. Other examples of the computing device 202 can be used without departing from the scope of the present disclosure. For example, the computing device 202 is an example of one or both of the first computing device 102 or the second computing device 114.

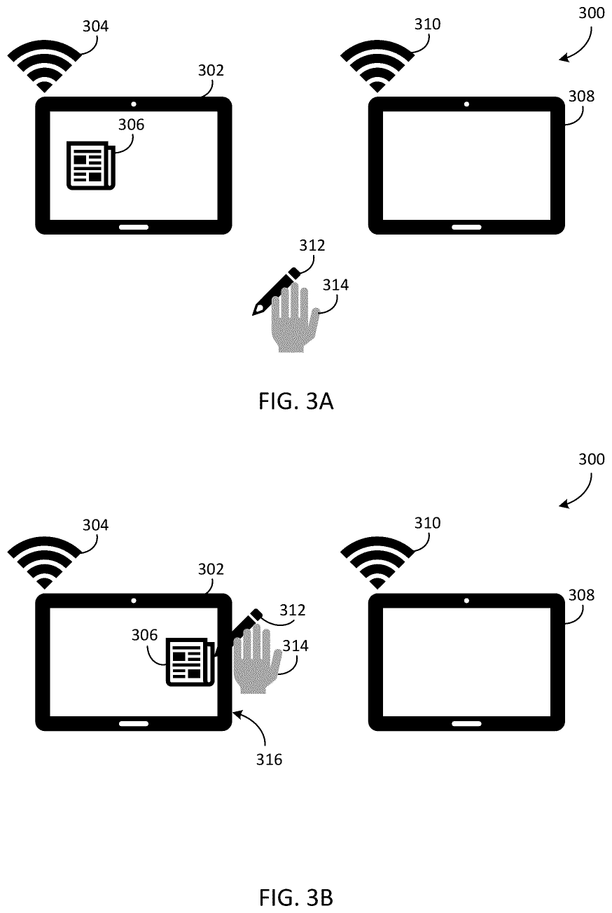

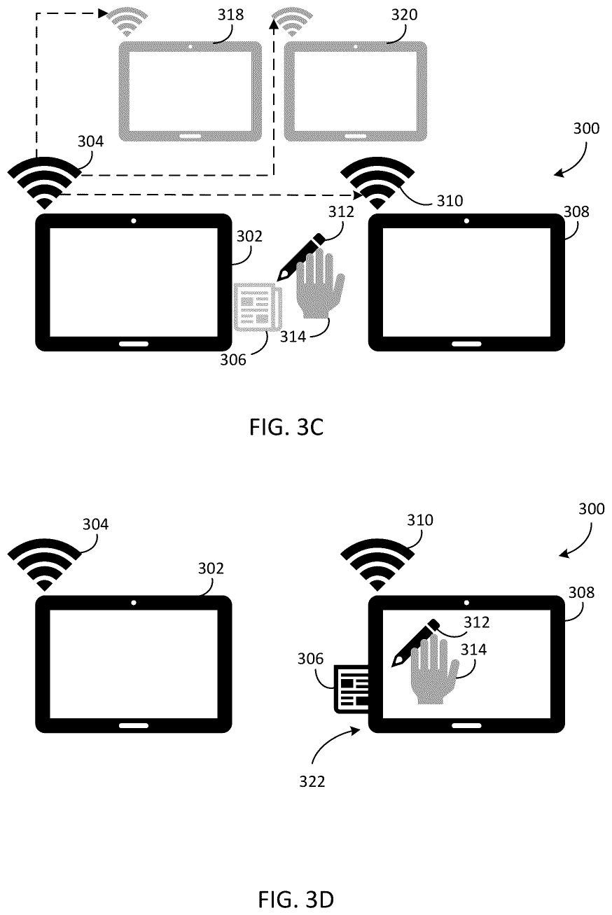

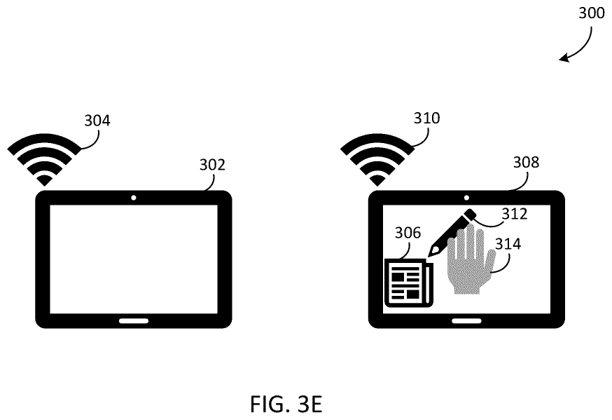

The computing device 202 includes a memory 204 that includes the computer-executable instructions 206, a processor 210, and a UI 222. The processor 210 includes any quantity of processing units, including but not limited to CPU(s), GPU(s), and NPU(s). The processor 210 is programmed to execute the computer-executable instructions 206. The computer-executable instructions 206 may be performed by the processor 210, performed by multiple processors 210 within the computing device 202, or performed by a processor external to the computing device 202. In some examples, the processor 210 is programmed to execute computer-executable instructions 206 such as those illustrated in the figures described herein, such as FIGS. 3-9. In various examples, the processor 210 is configured to execute one or more of the UI 222, a content transferor 228, and an authorizer 230. In other words, the content transferor 228 and the authorizer 230, and their respective sub-components described in greater detail below, are implemented on and/or by the processor 210.

The memory 204 includes any quantity of media associated with or accessible by the computing device 202. The memory 204 in these examples is internal to the computing device 202, as illustrated in FIG. 2. In other examples, the memory 204 is external to the computing device 202 or includes memory components both internal and external to the computing device 202. The memory 204 stores data, such as the computer-executable instructions 206 and one or more applications 208. The applications 208, when executed by the processor 210, operate to perform various functions on the computing device 202. The applications 208 communicate with counterpart applications or services, such as web services accessible via a network.

The user interface 222 includes a graphics card for displaying data to a user and receiving data from the user. The user interface 222 can also include computer-executable instructions, for example a driver, for operating the graphics card. Further, the user interface 222 can include a display, for example a touch screen display or natural user interface, and/or computer-executable instructions, for example a driver, for operating the display. The user interface 222 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor.

The UI 222 further includes a display edge 224 and presents, or displays, content 226 within the UI 222. As described herein, the computing device 202 presents the content 226 within boundaries of the UI 222 that include the display edge 224. In other words, the display edge 224 is a boundary of the UI 222 within which content, including the content 226, may be presented and outside of which content, including the content 226, is not presented. In some examples, the content 226 presented on the UI 222 is operable to be moved about the UI 222.

In other words, content 226 is moved from one location on the UI 222 to another location on the UI 222, such as in response to the UI 222 receiving an input from the input device 126.

The computing device 202 further includes a data storage device 212 for storing data, such as, but not limited to the data 214. The data storage device 212 in some non-limiting examples includes a redundant array of independent disks (RAID) array. The data storage device 212, in this example, is included within the computing device 202, attached to the computing device 202, plugged into the computing device 202, or otherwise associated with the computing device 202. In other examples, the data storage device 212 includes a remote data storage accessed by the computing device 202 via a network, such as a remote data storage device, a data storage in a remote data center, or a cloud storage.

The computing device 202 further includes a communications interface device 216.

The communications interface device 216 includes a network interface card and/or computer-executable instructions, such as a driver, for operating the network interface card.

Communication between the computing device 202 and other devices can occur using any protocol or mechanism over any wired or wireless connection. In some examples, the communications interface device 216 is operable with short range communication technologies such as by using near-field communication (NFC) tags.

The communications interface 216 further includes a beacon transceiver 218. The beacon transceiver 218 broadcasts, or transmits, a beacon 220, such as a BLE beacon as described herein. The beacon 220 includes device and content information related to the computing device 202 and the content 226 presented on the UI 222, respectively, including but not limited to a type of device of the computing device 202, an ID of the computing device 202, a size of the content 226, a position of the content 226 on the UI 222, an ID of the content 226, a type of content 226, a thumbnail of the content 226, and a URI of the content 226. The beacon transceiver 218 further receives another beacon 220 that is broadcast from a different iteration of a computing device 202.

The computing device 202 further includes a content transferor 228. The content transferor 228 transfers the content 226 from the computing device 202 to another computing device without exchanging credentials between the computing device 202 and the other computing device. The content transferor 228 determines a location, i.e., a display edge and a y-coordinate of another computing device, of another UI to which to transfer the content 226. In some examples, the content transferor 228 generates a representation of the content 226 and transfers the generated representation of the content 226 to the other UI. The generated representation includes a portion of the content 226 less than the full content 226. For example, where the content 226 is a file, the generated representation is a thumbnail of the file. In another example, where the content 226 is an application window, the generated representation is a static image of the last frame of the application window presented as the content 226 on the UI 222. However, these examples should not be construed as limiting. Various examples are possible without departing from the scope of the present disclosure. Following authorization and/or authentication of the other computing device by the authorizer 230, the content transferor 228 transfers the entirety of the content 226 to the other computing device.

The computing device 202 further includes the authorizer 230. The authorizer 230 executes an authorization and/or authentication protocol with another computing device that, when completed, either authorizes the other computing device to receive a completed transfer of content 226 or prevents the other computing device from receiving the completed transfer of content 226. In some examples, the authorization protocol includes confirming an identity of the other computing device, confirming the other computing device is approved for transferring content 226, and so forth.

Aspects of the disclosure are operable with any form of authorization protocol, such as Wi-Fi Protected Access II (WPA2), PIN-based protocols such Wi-Fi Direct, Transport Layer Security (TLS), Secure Sockets Layer (SSL), and more.

In some examples, the computing device 202 further includes a machine learning (ML) model 232. In other examples, the ML model 232 is provided as a cloud-computing component that is accessible by the computing device 202. The ML model 232 is a trained model that infers an intention to share displayed content 226. For example, the ML model 232 is trained using previous iterations of content transfers as inputs that identify drag-and-drop interaction patterns, proximities between computing devices, positions and orientations of computing devices, and whether each transfer was initiated and completed in order to learn and predict an intention to shared displayed content 226. Based on the inferred intention to share the displayed content 226, the ML model 232 controls the UI 222 to present a prompt that, when selected by the reception of another input (e.g., from the user), triggers the transfer of the displayed content 226 to another iteration of the computing device 202, such as the second computing device 114.

FIGS. 3A-3E illustrate a sequence of diagrams for automatic proximity detection with content sharing between devices according to an example. The diagrams illustrated in FIGS. 3A-3E are provided for illustration only and should not be construed as limiting. Other examples of the diagrams illustrated in FIGS. 3A-3E can be used without departing from the scope of the present disclosure.

FIG. 3A illustrates a system 300 including a first computing device 302, content 306 presented on the first computing device 302, and a second computing device 308. In some examples, the first computing device 302 is an example of the first computing device 102 and the second computing device 308 is an example of the second computing device 114, and each of the first computing device 302 and the second computing device 308 are embodiments of the computing device 202. The first computing device 302 includes a transceiver 304, which may be the transceiver 106 and/or the beacon transceiver 218, and the second computing device 308 includes a transceiver 310, which may be the transceiver 118 and/or the beacon transceiver 218. Accordingly, each of the transceiver 304 and the transceiver 310 are operable to broadcast, or transmit, and receive BLE beacons, such as the BLE beacon 220.

FIG. 3A further illustrates content 306. In some examples, the content 306 is an example of the content 112 and/or the content 226 described herein. Although the content 306 is illustrated in FIGS. 3A-3E as a file, various examples are possible. Various examples of the content 306 include, but are not limited to, an image, a video, a file, text, an application, and so forth.

FIG. 3A further illustrates an input device 312 and a user 314. The input device 312 is an example of the input device 126 and represents any type of device operable to provide an input to the first computing device 302 and/or the second computing device 308, including but not limited to a stylus, a finger of a user, a voice input (including a voice command to move the content 306 to the display edge 316), eye gaze, a keyboard, a mouse, a joystick, and so forth. The input device 312 is operated by the user 314. Although illustrated in FIG. 3A as separate, it should be understood that various examples of the present disclosure recognize and take into account that some implementations utilize a portion of the user 314, such as a finger of the user 314, as the input device 312 and a separate input device 312 is not included in the system 300.

As shown in FIG. 3A, the content 306 is presented on the first computing device 302, such as user interface of the first computing device 302. The input device 312 is illustrated as not presently providing an input to the first computing device 302 or the content 306. In some examples, the first computing device 302 and the second computing device 308 are unconnected in the system 300. In other words, the first computing device 302 and the second computing device 308 are not joined to the same network, have different user identities on each device, and/or are not electronically coupled by Bluetooth coupling or pairing.

FIG. 3B illustrates a next step in the system 300 where the first computing device 302 receives an input from the input device 312. The user, via input device 312, provides an input to the first computing device 302 at or in association with the content 306 presented on the first computing device 302. In some examples, the input includes a drag-and-drop operation that moves the content 306 to another location of the first computing device 302. For example, as shown in FIG. 3B, responsive to the input, the content 306 has moved across the interface of the first computing device 302 toward a display edge 316 of the first computing device 302.

FIG. 3C illustrates a next step in the system 300 where, responsive to the input by the input device 312 being at or approaching the display edge 316 of the first computing device 302 and/or the content 306 being at or approaching the display edge 316 of the first computing device 302, the transceiver 304 broadcasts a BLE beacon, such as the beacon 220. The broadcasted beacon indicates to all devices within a proximity of the first computing device 302 that the input is at or approaching the display edge 316 of the first computing device 302 and/or the content 306 is at or approaching the display edge 316 of the first computing device 302. In some examples, the broadcasted beacon includes an input device attribution indicating an ID of the input device 312 performing the input resulting in the beacon being broadcast. As shown in FIG. 3C, the broadcasted beacon is received by the second computing device 308 as well as additional computing devices 318, 320.

FIG. 3D illustrates the second computing device 308 receiving an input, i.e., a second input, from the input device 312. The second computing device 308 associates the received input from the input device 312 with the received beacon broadcast by the first computing device 302 indicating an input from the same input device 312 that performed the second input and, based on the association, determines the combination of interactions is an attempt to perform a cross-device drag-and-drop interaction and confirms the availability to receive the content 306 from the first computing device 302. In some examples, the second input may be provided by a finger or voice input of a user of the second computing device 308. As described herein, the transceiver 310 broadcasts a second beacon that is received by the first computing device 302 acknowledging the connection. One or both of the first computing device 302 and the second computing device 308 computes an n-coordinate, i.e., either an x- or ay-coordinate, and a display edge 322 at which the content 306 is to be presented on the second computing device 308 based on the n-coordinate and display edge 316 where the content 306 was previously presented and the orientation and position of the second computing device 308 relative to the first computing device 302.

FIG. 3E illustrates the second computing device 308 presenting the content 306 based on the transfer from the first computing device 302. Accordingly, as illustrated in FIGS. 3A-3E, the drag-and-drop operation initiated on the first computing device 302 transfers the content 306 from the first computing device 302 to the second computing device 308 without sharing credentials. For example, a Bluetooth pairing protocol is not executed between the first computing device 302 and the second computing device 308. For the second computing device 308, the first computing device 302 exhibits as a peripheral device. In some examples, the content 306 is transferred via a non-paired BLE connection. The beacon payload exposes a characteristic that contains the necessary details associated with the content 306 to show a visual representation of the content 306 and establish the link to initiate a full transfer later. The beacon payload is sufficient to maintain the seamless interaction with no pairing required, the destination device can simply read the values from the exposed characteristic. In another example, where BLE is unavailable or inconsistent, NFC is used via a similar mechanism described herein and the necessary content is included in the NFC payload. As described herein, the full content is not transferred at this time, as the content 306 transferred is a minimal representation of the content 306 and a link to enable a full content transfer later. Accordingly, a small payload is sufficient for the initial transfer over a short range communication. As described herein, a minimal representation of the content 306 includes one or more of an icon, thumbnail, or metadata that represents the full version of the content 306. In some examples, the metadata selected as the minimal representation is selected so as to not share private information until the full authorization is completed.

In some examples, the transfer illustrated in FIGS. 3A-3E is a transfer of a visual representation of the content 306 and following the transfer, an authorization protocol is executed in order to continue content 306 transfer. Upon successful completion of the authorization protocol, the transfer of the content 306 is authorized and a full transfer of the content 306 is performed to the second computing device 308. Where the authorization protocol is not successfully completed, i.e., the second computing device 308 is not authorized, the full transfer of the content 306 is not performed. In some examples, when the authorization protocol is successfully completed, a copy of the content 306 is transferred to the second computing device 308 and the content 306 continues to be displayed on the first computing device 302 at its initial position (e.g., when the drag-and-drop operation started as shown in FIG. 3A).

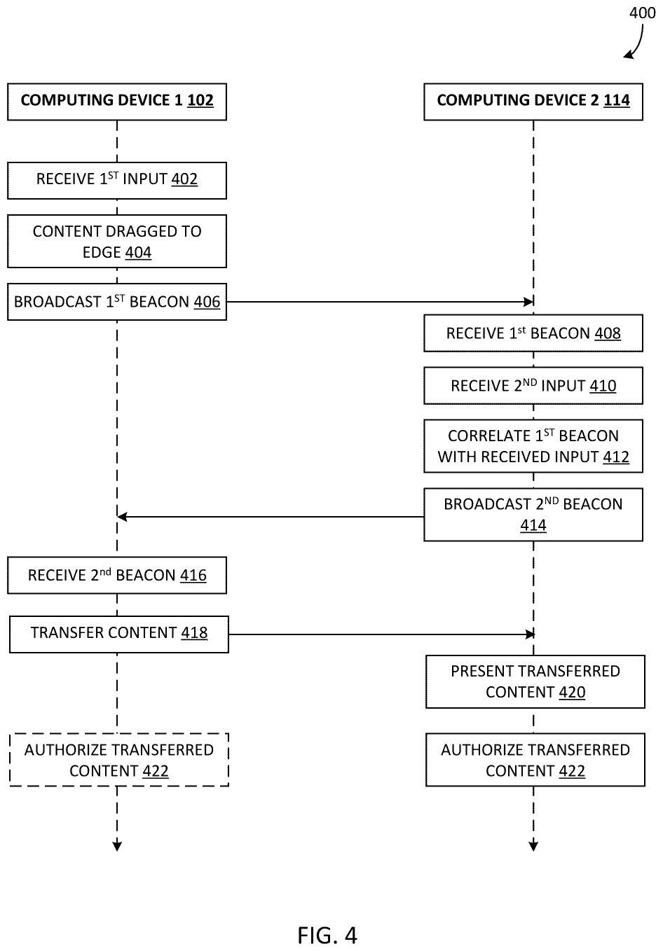

FIG. 4 is an example flowchart illustrating a computerized method of automatic proximity detection with content sharing between devices according to an example. The computerized method 400 illustrated in FIG. 4 is presented for illustration only and should not be construed as limiting. The computerized method 400 may be implemented by one or more computing devices described herein, such as the first computing device 102 and the second computing device 114.

The computerized method 400 begins by the first computing device 102 presenting content 112 on the UI 108 and receiving a first input from a user, via the input device 126, at a touch point in operation 402. In some examples, the first input is an input at or approaching the display edge 110 of the UI 108 directing the content 112 to approach the display edge 110 of the UI 108. In some examples, the first input is part of a drag-and-drop operation on the UI 108 that drags content 112 presented on the UI 108 to the display edge 110 of the UI 108. or a voice input on the UI 108 that causes the content 112 to be moved to the display edge 110 of the UI 108. In some examples, the UI 108 presents a drag box, such as a box to which the first input drags content 112 to be transferred to the second computing device 114. In operation 404, the content 112 is dragged to the display edge 110 of the UI 108 by the received first input.

In operation 406, the first computing device 102 broadcasts a first beacon, such as a BLE beacon. The broadcasted beacon may be received by any electronic device within the proximity of the first computing device 102 capable of receiving a BLE beacon. In some examples, the broadcasted beacon is referred to as a BLE advertisement, a BLE announcement, or a BLE advertising packet. The broadcasted beacon includes device and content information related to the first computing device 102 and the content 112 presented on the first computing device 102, respectively, including but not limited to a type of device of the first computing device 102, an ID of the first computing device 102, a size of the content 112, a position of the content 112 on the UI 108, an ID of the content 112, a type of content 112, a thumbnail of the content 112, a URI of the content 112, and/or an input device attribution indicating an ID of the input device 126 performing the input resulting in the beacon being broadcast. As described herein, the position of the content 112 includes (x, y) coordinates of the content 112 on the UI 108, and the type of content 112 includes a description of the content 112 including an application type, a file type, and so forth. In some examples, upon broadcasting the BLE beacon, the UI 108 hides the content 112 from the UI 108. In other words, upon broadcasting the BLE beacon, the content 112 is no longer presented on the UI 108. In other examples, upon broadcasting the BLE beacon, the UI 108 continues to display the content 112.

In operation 408, the second computing device 114 receives the broadcasted first beacon from the first computing device 102. In some examples, receiving the broadcasted first beacon includes capturing the advertised payload, including the device and content information related to the first computing device 102 and the content 112 presented on the first computing device 102, respectively.

In operation 410, the second computing device 114 receives an input, i.e., a second input, from a user via the input device 126. Receiving the input from the input device 126 includes receiving an input device attribution indicating the ID of the input device 126 that performs the input. In operation 412, the second computing device 114 correlates the received first beacon, broadcast from the first computing device 102, with the received second input from the input device 126 (e.g., based on the second input being received within a threshold time period of receiving the broadcasted first beacon). Additionally or alternatively, the second computing device 114 associates the ID of the input device 126 included in the broadcasted first beacon with the ID of the input device 126 that performs the second input, determines the IDs match, and correlates, or associates, the received first beacon with the received input to identify that the second input is an input to indicate an intent to transfer the content 112 specified in the first beacon to the second computing device 114. In some examples, following the received first beacon being correlated with the received second input, the UI 120 is shown with a size and thumbnail or a representative icon from the payload and position from the received second input. In operation 414, the second computing device 114 broadcasts, or transmits, a second beacon indicating an acknowledgement of the first beacon, correlation of the first beacon and the second input, and indicating acceptance of the transfer of the content 112 to the second computing device 114.

Although described herein as a single input device 126 providing both the first input in operation 402 and operation 410, various examples are possible. In some examples, the first computing device 102 is a personal device and the second computing device 114 is a shared device, such as a device in a conference room or other shared location. In this example, the second input is received at the first computing device 102 to confirm that the appropriate second computing device 114 is selected, enabling and authorizing the content 112 to be shared to the shared screen, i.e., the second computing device 114. In another example, the first computing device 102 is a personal device of a first user and the second computing device 114 is a personal device of a second user. In this example, the second input is received at the second computing device by a second iteration of the input device 126, i.e., a different input device that was used to provide the first input, to identify the appropriate second computing device 114 to which the content is to be transferred. In this example, a third input, received at the first computing device 102, is received to confirm the identified second computing device 114 is correct and authorize the content to be transferred to the second computing device 114.

In operation 416, the first computing device 102 receives the broadcasted second beacon and, in operation 418, transfers the content 112 to the second computing device 114 via BLE. Thus, the first computing device 102 transfers the content 112 to the second computing device 114 without the first computing device 102 sharing credentials with the second computing device 114. In some examples, the content 112 transferred in operation 418 is a visual representation of the content 112 as described herein. The transferred content is presented on the second computing device 114 as the content 124 in operation 420, the second computing device 114 presents the content 124 at the determined location on the UI 120. In some examples, a third input received at the UI 120 triggers the content 124 being transferred to the UI 120. In other examples, the content 124 is presented on the UI 120 without a third input being received.

In operation 422, the transfer of the content 112 to the second computing device 114 as the content 124 is authorized by one or both of first computing device 102 and the second computing device 114. In some examples, the authorization is performed by executing an authorization protocol as described herein to confirm the content 112 is transferred to the appropriate receiving device. Although the authorization in operation 422 is illustrated herein as occurring following the presented content being transferred in operation 420, various examples are possible. In some examples, the authorization of operation 422 may be performed prior to the transferred content being presented in operation 420 without departing from the scope of the present disclosure. For example, the second computing device 114 may be pre-authorized and included in a list of approved devices. The list of approved devices may include devices that have been authorized previously during previous iterations of the transfer and authorization processes, devices that have been pre-authorized without a previous transfer having been completed, devices belonging to an organization with shared permissions, and so forth. In another example, where a single user is signed in, or logged in, to both the first computing device 102 and the second computing device 114, the second computing device 114 is considered an approved device. The list of approved devices may be stored in a database, such as data 214 in the data storage device 212. In examples where pre-authorization occurs, the pre-authorization is verified in operation 422. It should be understood that the size of the BLE advertisement packet limits the quantity of content and metadata that may be received initially. Thus, the full transfer may be initiated based on a pre-authorization and completed after a confirmation of the pre-authorization.

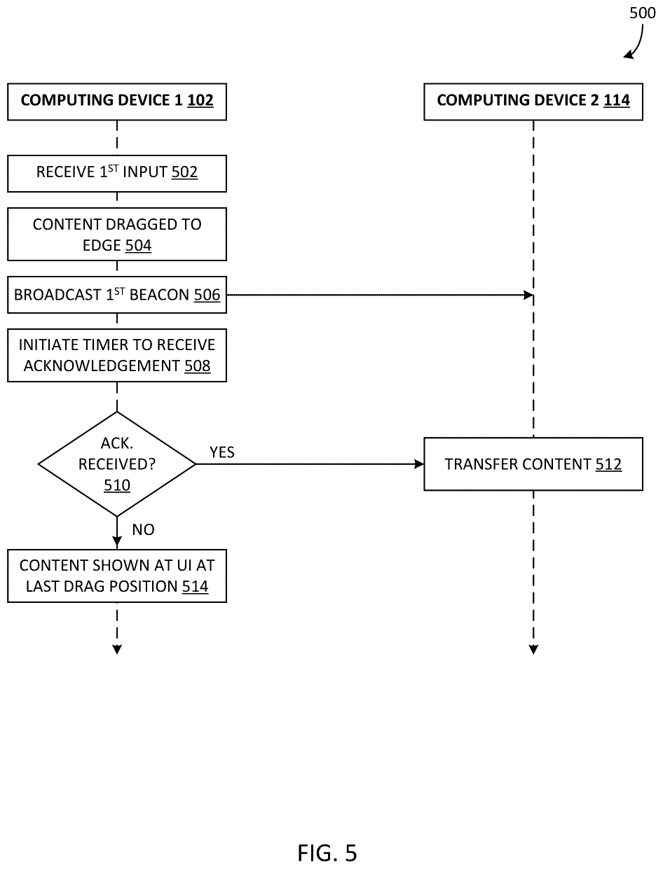

FIG. 5 is an example flowchart illustrating a computerized method of automatic proximity detection with content sharing between devices according to an example. The computerized method 500 illustrated in FIG. 5 is presented for illustration only and should not be construed as limiting. The computerized method 500 may be implemented by one or more computing devices described herein, such as the first computing device 102 and the second computing device 114.

The computerized method 500 begins by the first computing device 102 presenting content 112 on the UI 108 and receiving a first input from a user, via the input device 126, at a touch point in operation 502. In some examples, the first input is an input at or approaching the display edge 110 of the UI 108 directing the content 112 to approach the display edge 110 of the UI 108. In some examples, the first input is part of a drag-and-drop operation on the UI 108 that drags content 112 presented on the UI 108 to the display edge 110 of the UI 108 or a voice input on the UI 108 that causes the content 112 to be moved to the display edge 110 of the UI 108. In some examples, the UI 108 presents a drag box, such as a box to which the first input drags content 112 to be transferred to the second computing device 114. In operation 504, the content 112 is dragged to the display edge 110 of the UI 108 by the received first input.

In operation 506, the first computing device 102 broadcasts a first beacon, such as a BLE beacon. The broadcasted beacon may be received by any electronic device within the proximity of the first computing device 102 capable of receiving a BLE beacon. In some examples, the broadcasted beacon is referred to as a BLE announcement, a BLE advertising packet, or a BLE advertisement. The broadcasted beacon includes device and content information related to the first computing device 102 and the content 112 presented on the first computing device 102, respectively, including but not limited to a type of device of the first computing device 102, an ID of the first computing device 102, a size of the content 112, a position of the content 112 on the UI 108, an ID of the content 112, a type of content 112, a thumbnail of the content 112, a URI of the content 112, and/or an input device attribution indicating an ID of the input device 312 that a user manipulates to perform the input that results in the beacon being broadcast. As described herein, the position of the content 112 includes (x, y) coordinates of the content 112 on the UI 108, and the type of content 112 includes a description of the content 112 including an application type, a file type, and so forth. In some examples, upon broadcasting the BLE beacon, the UI 108 hides the content 112 from the UI 108. In other words, upon broadcasting the BLE beacon, the content 112 is no longer presented on the UI 108. In other examples, upon broadcasting the BLE beacon, the UI 108 continues to display the content 112.

In operation 508, the first computing device 102 initiates a timer to receive an acknowledgement from another computing device, such as the second computing device 114, indicating the broadcast beacon has been received and the second computing device 114 is ready to receive the content 112. In operation 510, the first computing device 102 determines whether the acknowledgement is received prior to the initiated timer expiring. In examples where the acknowledgement is received, in operation 512 the content 112 is transferred to the second computing device 114, such as by performing operations 418-424 illustrated in FIG. 4 and described herein. In examples where the acknowledgment is not received prior to the expiration of the timer, in operation 514 the first computing device 102 presents the content 112 at the last drag position where the input was received on the UI 108 and the content 112 is not presented on the second computing device 114.

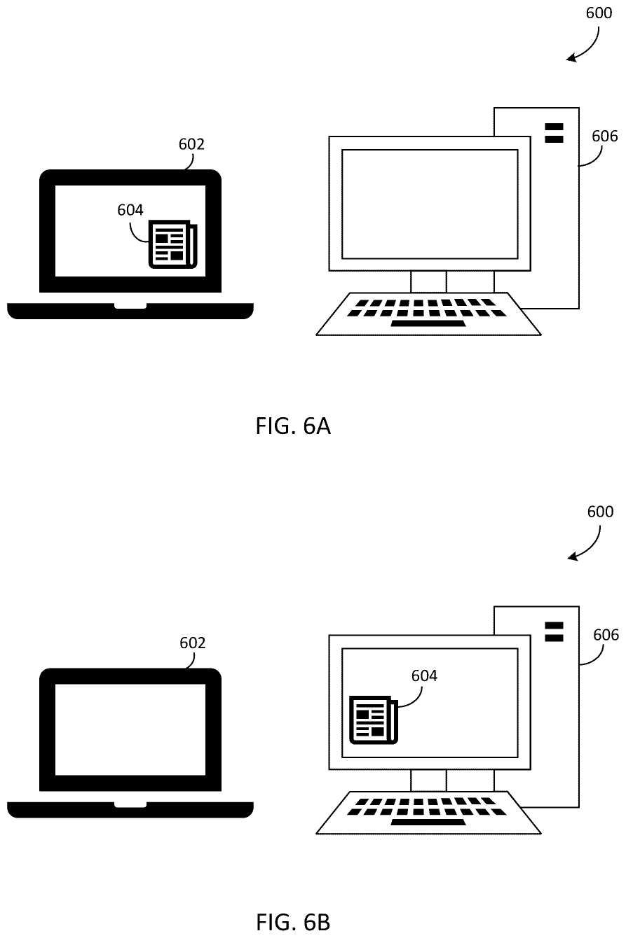

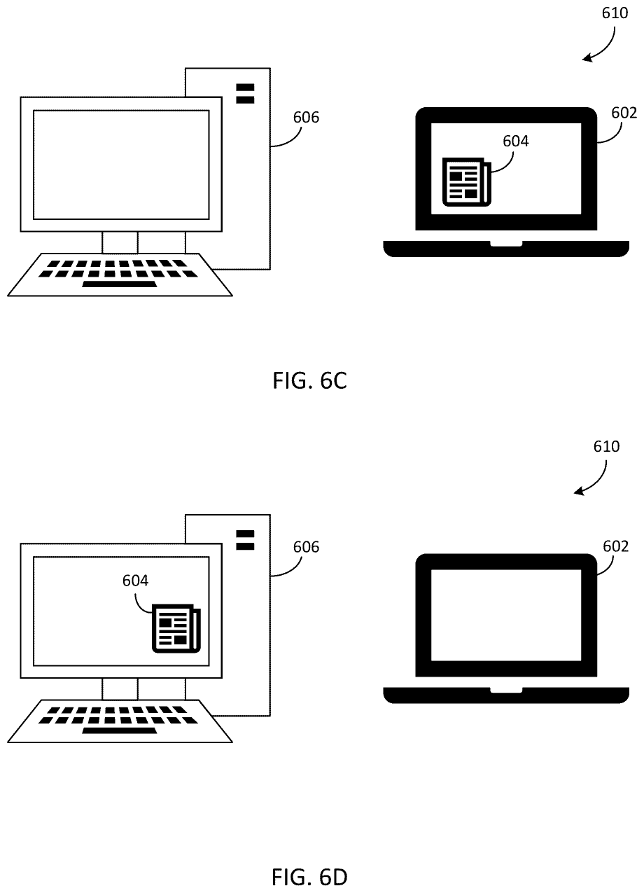

FIGS. 6A-6D illustrate a sequence of block diagrams for automatic proximity detection with content sharing between devices according to an example. The diagrams illustrated in FIGS. 6A-6D are provided for illustration only and should not be construed as limiting. Other examples of the diagrams illustrated in FIGS. 6A-6D can be used without departing from the scope of the present disclosure.

FIG. 6A illustrates a system 600 including a first computing device 602, content 604 presented on the first computing device 602, and a second computing device 606. In some examples, the first computing device 602 is an example of the first computing device 102 and the second computing device 606 is an example of the second computing device 114, and each of the first computing device 602 and the second computing device 606 are embodiments of the computing device 202.

FIG. 6A further illustrates content 604. In some examples, the content 604 is an example of the content 112 and/or the content 226 described herein. Although the content 604 is illustrated in FIGS. 6A and 6B as a file, various examples are possible. Various examples of the content 604 include, but are not limited to, an image, a video, a file, text, an application, a website, and so forth.

As shown in FIG. 6A, the content 604 is presented on the first computing device 602, such as user interface of the first computing device 602. In some examples, the first computing device 602 and the second computing device 606 are unconnected in the system 600. In other words, the first computing device 602 and the second computing device 606 are not joined to the same network, have different user identities on each device, and are not electronically coupled by Bluetooth coupling or pairing. The second computing device 606 initiates a wireless display connection with the first computing device 602, and the first computing device 602 automatically adjusts its orientation and position based on the wireless display connection. For example, the orientation as illustrated in FIG. 6A and viewed from the perspective of FIG. 6A includes the first computing device 602 on a left side of the second computing device 606. The proximity, location, and orientation of the computing devices 602 and 606 are determined based on at least one of a strength and direction of a received wireless display signal, a received BLE beacon, a received ultra-wideband (UWB) signal, and a received touch input.

Accordingly, the first computing device 602 determines a cardinal relation to the second computing device 606 and adjusts the display to match the determined relation to the second computing device 606.

In examples where the proximity, location, and orientation are not determined based on a received UWB signal, an indicator is dragged from a source device, i.e., the first computing device 602 presenting the content 604, to a target device, i.e., the second computing device 606. The wireless display connection is established based on a beacon, such as a BLE beacon, being broadcast by the first computing device 602 and received by the second computing device 606 and then a second beacon, such as a second BLE beacon, being broadcast by the second computing device 606 and received by the first computing device 602 as described herein. The relative orientation of the first computing device 602 and the second computing device 606 is determined based on the angle of interaction. The angle of interaction is computed between the exit coordinate from the first computing device 102 and the entrance coordinate of the second computing device 114. The computed angle of interaction will intersect with a display edge of the first computing device 102 and a display edge of the second computing device 114. The display edges are established as parallel to one another, assuming the interaction takes place as the angle of interaction. The display edges, once established as parallel, determine the relative orientation of each computing device to each other. Upon the wireless connection being established, the content 604 is transferred to the second computing device 606 as described herein. For example, FIG. 6B illustrates a result of the content 604 being transferred to the second computing device 606 at the determined relative orientation and position of the first computing device 602 and the second computing device 606.

FIGS. 6C-6D illustrate another example of transferring content from one computing device to another. Relative to FIGS. 6A-6B, FIGS. 6C-6D illustrate an example where the relative orientation and position of the computing devices 602 and 606 is opposite that of FIGS. 6A-6B. In other words, FIGS. 6A-6B illustrate an example where the first computing device 602 is located on a left side of the second computing device 606 and the content 604 is transferred from the first computing device 602 to the second computing device 606, whereas the system 610 illustrated in FIGS. 6C-6D illustrate an example where the first computing device 602 is located on a right side of the second computing device 606. Accordingly, the relative orientation to transfer the content 604 is flipped relative to the orientation and position depicted in FIGS. 6A-6B.

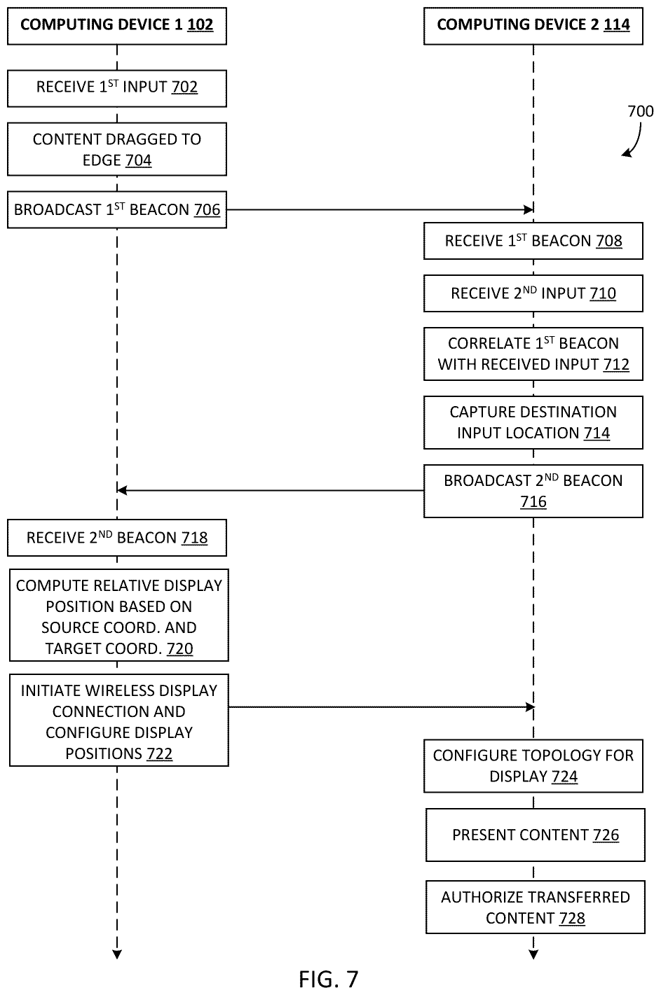

FIG. 7 is an example flowchart illustrating a computerized method of automatic proximity detection with content sharing between devices according to an example. The computerized method 700 illustrated in FIG. 7 is presented for illustration only and should not be construed as limiting. The computerized method 700 may be implemented by one or more computing devices described herein, such as the first computing device 102 and the second computing device 114.

The computerized method 700 begins by the first computing device 102 presenting content 112 on the UI 108 and receiving a first input from a user, via the input device 126, at a touch point in operation 702. In some examples, the first input is an input at or approaching the display edge 110 of the UI 108 directing the content 112 to approach the display edge 110 of the UI 108. In some examples, the first input is part of a drag-and-drop operation on the UI 108 that drags content 112 presented on the UI 108 to the display edge 110 of the UI 108 or a voice input on the UI 108 that causes the content 112 to be moved to the display edge 110 of the UI 108. In some examples, the UI 108 presents a drag box, such as a box to which the first input drags content 112 to be transferred to the second computing device 114. In operation 704, the content 112 is dragged to the display edge 110 of the UI 108 by the received first input.

In operation 706, the first computing device 102 broadcasts a first beacon, such as a BLE beacon. The broadcasted beacon may be received by any electronic device within the proximity of the first computing device 102 capable of receiving a BLE beacon. In some examples, the broadcasted beacon is referred to as a BLE announcement, a BLE advertising packet, or a BLE advertisement. The broadcasted beacon includes device and content information related to the first computing device 102 and the content 112 presented on the first computing device 102, respectively, including but not limited to a type of device of the first computing device 102, an ID of the first computing device 102, a size of the content 112, a position of the content 112 on the UI 108, an ID of the content 112, a type of content 112, a thumbnail of the content 112, a URI of the content 112, and/or an input device attribution indicating an ID of the input device 126 performing the input resulting in the beacon being broadcast. As described herein, the position of the content 112 includes (x, y) coordinates of the content 112 on the UI 108, and the type of content 112 includes a description of the content 112 including an application type, a file type, and so forth. In some examples, upon broadcasting the BLE beacon, the UI 108 hides the content 112 from the UI 108. In other words, upon broadcasting the BLE beacon, the content 112 is no longer presented on the UI 108. In other examples, upon broadcasting the BLE beacon, the UI 108 continues to display the content 112.

In operation 708, the second computing device 114 receives the broadcasted first beacon from the first computing device 102. In some examples, receiving the broadcasted first beacon includes capturing the advertised payload, including the device and content information related to the first computing device 102 and the content 112 presented on the first computing device 102, respectively.

In operation 710, the second computing device 114 receives an input, i.e., a second input, from the input device 126. Receiving the input from the input device 126 includes receiving an input device attribution indicating the ID of the input device 126 that performs the input. In operation 712, the second computing device 114 correlates the received first beacon, broadcast from the first computing device 102, with the received second input from the input device 126 (e.g., based on the second input being received within a threshold time period of receiving the broadcasted first beacon). Additionally or alternatively, the second computing device 114 associates the ID of the input device 126 included in the broadcasted first beacon with the ID of the input device 126 that performs the second input, determines the IDs match, and correlates, or associates, the received first beacon with the received input to identify that the second input is an input to indicate an intent to transfer the content 112 specified in the first beacon to the second computing device 114. In some examples, following the received first beacon being correlated with the received second input, the UI 120 is shown with a size and thumbnail or a representative icon from the payload and position from the received second input.

In operation 714, the second computing device 114 captures a destination input location for the content 112. The destination input location is a location of the second computing device 114 relative to the first computing device 102. In operation 716, the second computing device 114 broadcasts, or transmits, a second beacon indicating an acknowledgement of the first beacon, correlation of the first beacon and the second input, destination coordinates as computed in operation 714, a wireless display connection string, and indicating acceptance of the transfer of the content 112 to the captured destination input location of the second computing device 114. In operation 718, the broadcasted second beacon is received by the first computing device 102. The wireless display connection string includes information about the devices being connected, the network being used, and any authorization, authentication, or other security measures used to establish the connection. An example connection string includes names of the devices, a randomly generated code (e.g., personal identification number), and the network to be used for communication.

In operation 720, the first computing device 102 computes the relative display position based on the source coordinates, i.e., the coordinates of the first computing device 102, and the target coordinates, i.e., the coordinates of the second computing device 114. For example, the first computing device 102 computes the coordinates of the display edge 122 of the UI 120 based on the known coordinates of the display edge 110 of the UI 108, as described herein. In operation 722, the first computing device 102 initiates a wireless display connection with the second computing device 114 and configures a display position of the first computing device 102 relative to the second computing device 114.

In operation 724, the second computing device 114 configures topology of the UI 120 for displaying the content 112 from the first computing device. In some examples, configuring the topology includes receiving and identifying the (x, y) coordinates of the UI 120 upon which the content 112 is to be displayed as the content 124. In some examples, the topology is configured using an API that allows displays to be configured at a specific orientation; based on the orientation values that were calculated as described herein.

In operation 726, the second computing device 114 presents the content 124 at the determined location on the UI 120. In operation 728, the transfer of the content 112 to the second computing device 114 as the content 124 is authorized by one or both of first computing device 102 and the second computing device 114. In some examples, the authorization is performed by executing an authorization protocol to confirm the content 112 is transferred to the appropriate receiving device. In some examples, the authorization of operation 728 may be performed prior to the transferred content being presented in operation 726 without departing from the scope of the present disclosure. For example, the second computing device 114 may be pre-authorized and included in a list of approved devices. The list of approved devices may include devices that have been authorized previously during previous iterations of the transfer and authorization processes, devices that have been pre-authorized without a previous transfer having been completed, devices belonging to an organization with shared permissions, and so forth. In another example, where a single user is signed in, or logged in, to both the first computing device 102 and the second computing device 114, the second computing device 114 is considered an approved device. The list of approved devices may be stored in a database, such as data 214 in the data storage device 212. In examples where pre-authorization occurs, the pre-authorization is verified in operation 728. It should be understood that the size of the BLE advertisement packet limits the quantity of content and metadata that may be received initially. Thus, the full transfer may be initiated based on a pre-authorization and completed after a confirmation of the pre-authorization.

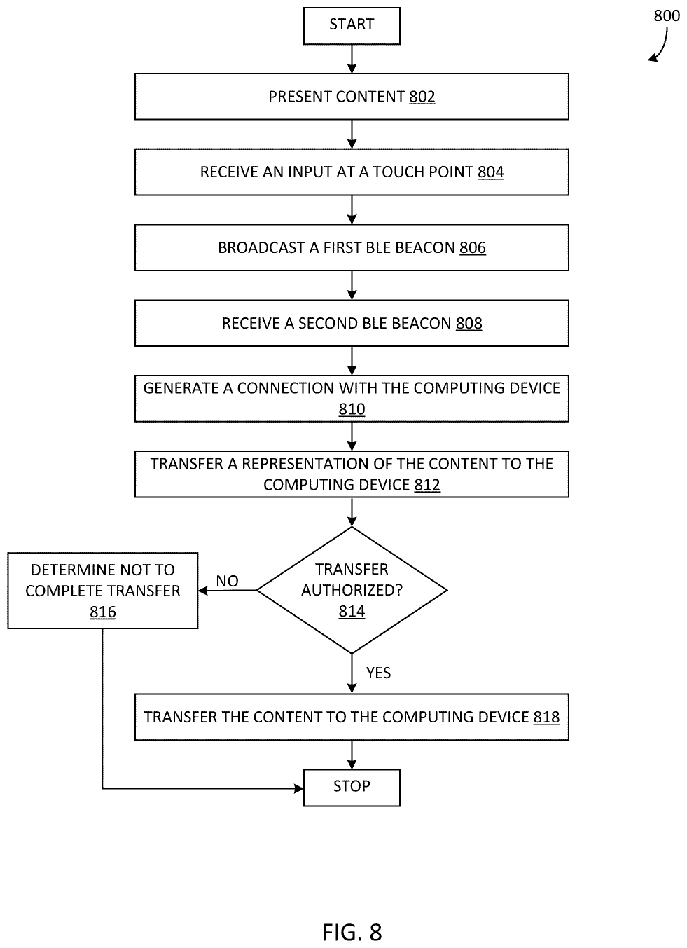

FIG. 8 is an example flowchart illustrating a computerized method of automatic proximity detection with content sharing between devices according to an example. The computerized method 800 illustrated in FIG. 8 is presented for illustration only and should not be construed as limiting. The computerized method 800 may be implemented by one or more computing devices described herein, such as the first computing device 102.

The computerized method 800 begins by the first computing device 102 presenting content 112 on the UI 108 in operation 802. As described herein, the content 112 represents any type of content presented on a UI 108, including but not limited to an image, a video, a file, text, an application, and so forth.

In operation 804, the first computing device 102 receives an input at a touch point. The touch point is a physical location on the UI 108 at which the input is received. In some examples, the input is received from the input device 126. In other examples, the input is received from a user, such as the finger of the user 314. The input may be a single input, such as a touch where the UI 108 is contacted and then the touch is released at the same location. In other examples, the touch includes an initial contact point and a release point that are different, such as in a drag-and-drop operation.

In operation 806, the first computing device 102 broadcasts a first BLE beacon in response to the touch point being at the display edge 110 of the UI 108. The broadcasted beacon is an advertisement to other computing devices in proximity to the first computing device 102 to potentially transfer the content 112. In some examples, the broadcasted beacon is received at least by the second computing device 114.

In some examples, the first computing device 102 initiates, or triggers, a timer to receive an acknowledgement from the second computing device 114, indicating the broadcast beacon has been received and the second computing device 114 is ready to receive the content 112.

In operation 808, the first computing device 102 receives a second BLE beacon within the time period of the timer. The received BLE beacon includes an identification of the second computing device 114 proximate to the display edge of the UI 108 and a confirmation of a location of the second computing device 114 based on a second input being received at the second computing device 114. For example, the second computing device 114 receives a second input from the input device 126 that performs the first input at the first computing device 102, associates an ID of the input device 126 with the received first BLE beacon, and broadcasts the second BLE beacon acknowledging the intent to transfer the content 112 to the second computing device 114 and confirming acceptance. In operation 810, in response to receiving the second BLE beacon, the first computing device 102 generates a connection with the second computing device 114.

In operation 812, the first computing device 102 transfers a representation of the content 112. The representation includes a portion of the content 112 less than the full content 112. For example, where the content 112 is a file, the representation is a thumbnail of the file.

In another example, where the content 112 is an application window, the representation is a static image of the last frame of the application window presented as the content 112 on the UI 108. In another example, the representation is a live image of the last frame of the application window presented as the content 112 on the UI 108.

In operation 814, the first computing device 102 executes an authorization protocol to determine whether the second computing device 114 is authorized to receive the full content 112. In response to the first computing device 102 determining the second computing device 114 is not authorized, in operation 816 the first computing device 102 determines not to complete the transfer of the content 112 to the second computing device 114. In response to the first computing device 102 determining the second computing device 114 is authorized, in operation 818 the first computing device 102 transfers the full content to the second computing device 114.

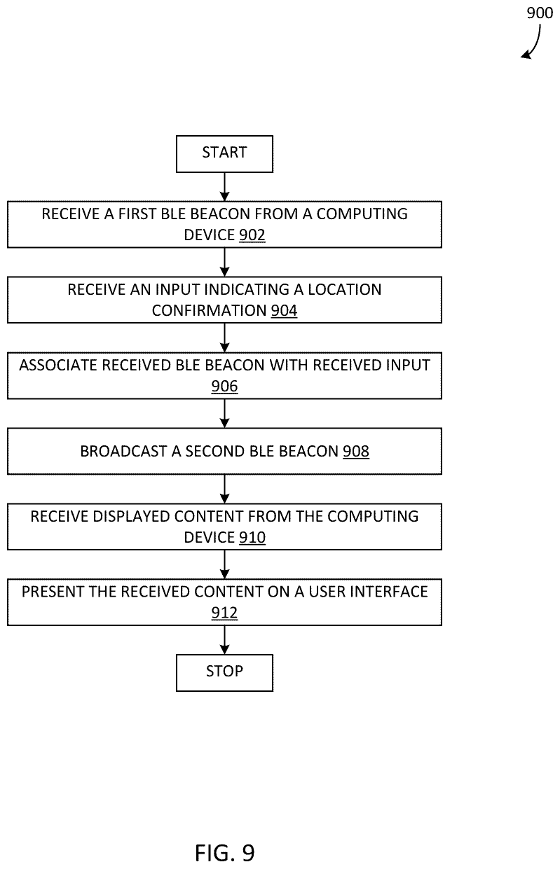

FIG. 9 is an example flowchart illustrating a computerized method of automatic proximity detection with content sharing between devices according to an example. The computerized method 900 illustrated in FIG. 9 is presented for illustration only and should not be construed as limiting. The computerized method 900 may be implemented by one or more computing devices described herein, such as the second computing device 114.

The computerized method 900 begins by the second computing device 114 receiving a first BLE beacon from the first computing device 102 in operation 902. The first BLE beacon is broadcast from the first computing device 102 in response to a touch point of an input device, such as the input device 126, being at the display edge 110 of the UI 108 of the first computing device 102.

In operation 904, the second computing device 114 receives an input indicating a location confirmation at the UI 120. In some examples, the input is received from the input device 126 and includes an ID of the input device 126. In some examples, the input indicates a position at which the received content is to be displayed on the UI 120.

In operation 906, the second computing device 114 associates the received first BLE beacon with the received input. For example, the second computing device 114 confirms the input device ID included in the received first BLE beacon matches the input device ID with the input device 126 that performs the input indicating the location confirmation.

In operation 908, the second computing device 114 broadcasts a second BLE beacon.

The second BLE beacon includes an identification of the second computing device 114 proximate to the display edge 110 of the UI 108 and a confirmation of a location of the second computing device 114 based on the received input. The broadcasted second BLE beacon is received by the first computing device 102 which, based on the received BLE beacon, determines to transfer the content 112 to the second computing device 114.

In some examples, the second computing device 114 computes a y-coordinate at which the content is to be presented on the UI 120. For example, the display edge 110 of the UI 108 includes a first y-coordinate, the display edge 122 of the UI 120 includes a second y-coordinate, and the second computing device 114 computes the appropriate y-coordinate at which to present the content 112 as the content 124.

In operation 910, the second computing device 114 receives the content 112 from the first computing device 102 and in operation 912, presents the received content 112 on the UI 120 as the content 112 according to the computed y-coordinate of the UI 120.

### Additional Examples

Aspects of the disclosure have numerous practical applications. For example, the techniques described herein enable connection of a computing device to an external monitor for moving (or duplicating) content from a display of the computing device to the external monitor, without having to make any manual adjustments to position or orientation settings of the external monitor. In another example, a new personal computer of a user can automatically connect to an old personal computer of the user for improved content access across the screens, or using one of the personal computers as an extension of the other. In still another example, a computing device of a teacher can be used to share content with multiple class members by placing the computing device near computing devices of the class members and sharing content using techniques described herein.

In another example, the techniques described herein enable content sharing between a device owned by the user and a device owned by a different user, even in situations where the two devices have no natural identity connection between each other. In another example, the techniques described herein enable a user that utilizes multiple devices they frequently use together or simultaneously enables the seamless interaction across the devices.

### Exemplary Operating Environment

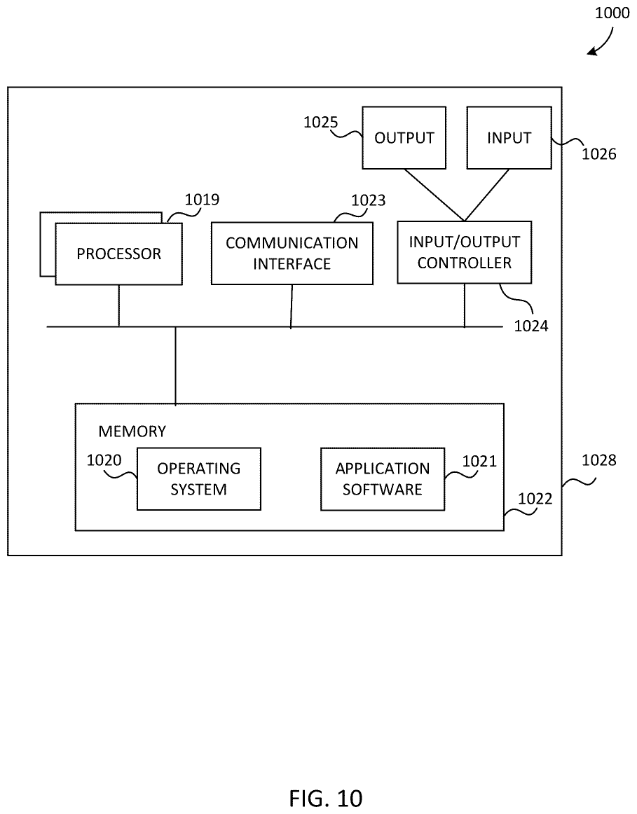

The present disclosure is operable with a computing apparatus according to an example as a functional block diagram 1000 in FIG. 10. In an example, components of a computing apparatus 1028 may be implemented as a part of an electronic device according to one or more examples described in this specification. For example, the computing apparatus 1028 can be the first computing device 102 illustrated in FIG. 1 and/or the computing device 202 illustrated in FIG. 2. The computing apparatus 1028 comprises one or more processors 1019 which may be microprocessors, controllers, or any other suitable type of processors for processing computer executable instructions to control the operation of the electronic device. Alternatively, or in addition, the processor 1019 is any technology capable of executing logic or instructions, such as a hardcoded machine. Platform software comprising an operating system 1020 or any other suitable platform software may be provided on the apparatus 1028 to enable application software 1021 to be executed on the device.

Computer executable instructions may be provided using any computer-readable media that are accessible by the computing apparatus 1028. Computer-readable media may include, for example, computer storage media such as a memory 1022 and communications media. Computer storage media, such as a memory 1022, include volatile and non-volatile, removable, and non-removable media implemented in any method or technology for storage of information such as computer readable instructions, data structures, program modules or the like. Computer storage media include, but are not limited to, RAM, ROM, EPROM, EEPROM, persistent memory, phase change memory, flash memory or other memory technology, CD-ROM, digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 1022) is shown within the computing apparatus 1028, it will be appreciated by a person skilled in the art, that the storage may be distributed or located remotely and accessed via a network or other communication link (e.g., using a communication interface 1023).

In some examples, the computer-readable media includes instructions that, when executed by the processor 1019, execute instructions for the communications interface device 216, user interface 222, content transferor 228, and/or the authorizer 230.

The computing apparatus 1028 may comprise an input/output controller 1024 configured to output information to one or more output devices 1025, for example a display or a speaker, which may be separate from or integral to the electronic device. For example, the output device 1025 can be a user interface. The input/output controller 1024 may also be configured to receive and process an input from one or more input devices 1026, for example, a keyboard, a microphone, or a touchpad. In some examples, the one or more input devices 1026 is an input reception module. In one example, the output device 1025 may also act as the input device. An example of such a device may be a touch sensitive display that functions as both the input/output controller 1024. The input/output controller 1024 may also output data to devices other than the output device, e.g., a locally connected printing device. In some examples, a user may provide input to the input device(s) 1026 and/or receive output from the output device(s) 1025.

The functionality described herein can be performed, at least in part, by one or more hardware logic components. According to an example, the computing apparatus 1028 is configured by the program code when executed by the processor 1019 to execute the examples of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an example computing device, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality (MR) devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

In examples involving a general-purpose computer, aspects of the disclosure transform the general-purpose computer into a special-purpose computing device when configured to execute the instructions described herein.

An example system for automatic proximity detection with content sharing between devices includes a first computing device and a second computing device. The first computing device includes a first memory, a first user interface that displays content, a first transceiver, and a first processor coupled to the first memory that, in response to a touch point of an input device being at a display edge of the first UI, controls the first transceiver to broadcast a first beacon, controls the first transceiver to receive a second beacon from a second computing device, the received second beacon including an identification of the second computing device proximate to the display edge of the first UI and a confirmation of a location of the second computing device based on an input being received at the second computing device, generates a connection with the second computing device to transfer the display content, and transfers, via the generated connection, the displayed content to the second computing device. The second computing device includes a second memory, a second user interface, and a second transceiver that receives, from the first processor, the broadcasted first beacon, receives, from the input device, the input indicating the location confirmation, broadcasts the second beacon, and receives the displayed content from the first computing device. The second computing device further includes a second processor that presents, on the second UI, the received content at a display edge of the second UI proximate to the display edge of the first UI.

An example computer-implemented method for automatic proximity detection with content sharing between devices includes displaying content on a user interface (UI), in response to a touch point of an input device being at a display edge of the UI, broadcasting a first beacon, receiving, from a computing device, a second beacon, the received second beacon including an identification of the computing device proximate to the display edge of the UI and a confirmation of a location of the computing device based on an input being received at the computing device, generating a connection with the computing device to transfer the display content, and transferring, via the generated connection, the displayed content to the computing device, wherein the transferred content is displayed on the computing device.

Examples of computer-readable storage media store computer-executable instructions for automatic proximity detection with content sharing between devices that, upon execution by a processor on a first computing device, cause the processor to receive, from a second computing device, a broadcasted beacon, wherein the broadcasted beacon is broadcast in response to a touch point of an input device being at a display edge of a user interface (UI) of the second computing device, receive an input confirming a location of the first computing device, broadcast a second beacon, receive, from the second computing device, content previously displayed on the UI of the second computing device, and present, on a UI of the first computing device, the received content at a display edge of the UI of the first computing device proximate to the display edge of the UI of the second computing device.

Alternatively, or in addition to the other examples described herein, examples include any combination of the following:
wherein the display edge of the first UI includes a first y-coordinate; and the display edge of the second UI includes a second y-coordinate;
wherein the second processor further: computes the second y-coordinate based on the first y-coordinate; and presents the received content at the display edge of the second UI according to the computed second y-coordinate;
wherein the first processor further: determines the received second beacon includes an indication to receive a payload;
wherein the input received at the second computing device further indicates a position at which the received content is to be displayed on the second UI;
wherein the first processor further: determines, based on the received second beacon, a position of the second computing device relative to the first computing device and an orientation of the second computing device relative to the first computing device;
wherein the second processor further: presents, on the second UI, the received content at a display edge of the second UI according to the determined position and orientation of the second computing device relative to the first computing device;
wherein the first processor further: generates a representation of the displayed content; and transfers the generated representation of the displayed content to the second computing device;
wherein the first processor further: executes an authorization protocol with the second computing device; in response to the executed authorization protocol, authorizes the second computing device to receive an entirety of the displayed content; and transfers the entirety of the displayed content to the second computing device;
wherein the touch point is a portion of a drag and drop input;
wherein the first processor further: in response to broadcasting the first beacon, triggers a timer for acknowledgement from the second computing device, the timer including a time period to receive the acknowledgement; and receives the location confirmation based on the input being received at the second computing device within the time period to receive the acknowledgement, wherein the input received at the second computing device is the acknowledgement; and
wherein the first computing device further comprises a machine learning (ML) model, implemented on the first processor, that: infers an intention to share the displayed content; and based on the inferred intention to share the displayed content, presents, on the first UI, a prompt that, when selected, triggers the transfer of the displayed content to the second computing device.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one example or may relate to several examples. The examples are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

1. A system comprising:
a first computing device comprising:
a first memory;
a first user interface (UI) that displays content;
a first transceiver; and
a first processor coupled to the first memory that:
in response to a touch point of a first input being at a display edge of the first UI, controls the first transceiver to broadcast a first beacon,
controls the first transceiver to receive a second beacon from a second computing device, the received second beacon including an identification of the second computing device proximate to the display edge of the first UI,
generates a connection with the second computing device, and
transfers, via the generated connection, the displayed content to the second computing device; and
the second computing device comprising:
a second memory;
a second UI;
a second transceiver that
receives, from the first transceiver, the broadcasted first beacon,
receives a second input indicating a location confirmation,
broadcasts the second beacon, and
receives the displayed content from the first computing device; and
a second processor coupled to the second memory that presents, on the second UI, the received content at a display edge of the second UI proximate to the display edge of the first UI.

2. The system of claim 1, wherein:
the display edge of the first UI includes a first y-coordinate; and
the display edge of the second UI includes a second y-coordinate.

3. The system of claim 2, wherein the second processor further:
computes the second y-coordinate based on the first y-coordinate; and
presents the received content at the display edge of the second UI according to the computed second y-coordinate.

4. The system of claim 1, wherein the first processor further:
determines that the received second beacon includes an indication to receive a payload.

5. The system of claim 1, wherein the input received at the second computing device further indicates a position at which the received content is to be displayed on the second UI.

6. The system of claim 1, wherein the first processor further:
determines, based on the received second beacon, a position of the second computing device relative to the first computing device and an orientation of the second computing device relative to the first computing device.

7. The system of claim 6, wherein the second processor further:
presents, on the second UI, the received content at the display edge of the second UI according to the determined position and orientation of the second computing device relative to the first computing device.

8. The system of claim 1, wherein the first processor further:
generates a representation of the displayed content; and
transfers the generated representation of the displayed content to the second computing device.

9. The system of claim 8, wherein the first processor further:
executes an authorization protocol with the second computing device;
in response to the executed authorization protocol, authorizes the second computing device to receive an entirety of the displayed content; and
transfers the entirety of the displayed content to the second computing device.

10. The system of claim 1, wherein the touch point is a portion of a drag and drop input.

11. The system of claim 1, wherein the first processor further:
in response to broadcasting the first beacon, triggers a timer for acknowledgement from the second computing device, the timer including a time period to receive the acknowledgement; and
receives the location confirmation based on the input being received at the second computing device within the time period to receive the acknowledgement, wherein the input received at the second computing device is the acknowledgement.

12. The system of claim 1, wherein the first computing device further comprises a machine learning (ML) model, implemented on the first processor, that:
infers an intention to share the displayed content; and
based on the inferred intention to share the displayed content, presents, on the first UI, a prompt that, when selected, triggers the transfer of the displayed content to the second computing device.

13. A computer-implemented method comprising:
displaying content on a user interface (UI);
in response to a touch point of an input being at a display edge of the UI, broadcasting a first beacon;
receiving, from a computing device, a second beacon, the received second beacon including an identification of the computing device proximate to the display edge of the UI and a confirmation of a location of the computing device based on an input being received at the computing device;
generating a connection with the computing device to transfer the display content; and
transferring, via the generated connection, the displayed content to the computing device, wherein the transferred content is displayed on the computing device.

14. The computer-implemented method of claim 13, further comprising:
determining, based on the received second beacon, a position of the computing device relative to the UI and an orientation of the computing device relative to the UI.

15. The computer-implemented method of claim 13, further comprising:
generating a representation of the displayed content; and
transferring the generated representation of the displayed content to the computing device.

16. The computer-implemented method of claim 15, further comprising:
executing an authorization protocol with the computing device;
in response to the executed authorization protocol, authorizing the computing device to receive an entirety of the displayed content; and
transferring the entirety of the displayed content to the computing device.

17. The computer-implemented method of claim 13, further comprising:
in response to receiving the second beacon from the computing device, triggering a timer for acknowledgement from the computing device, the timer including a time period to receive the acknowledgement; and
receiving the location confirmation based on the input being received at the computing device within the time period to receive the acknowledgement, wherein the input received at the computing device is the acknowledgement.

18. A computer-readable medium storing instructions that, when executed by a processor on a first computing device, cause the processor to:
receive, from a second computing device, a broadcasted beacon, wherein the broadcasted beacon is broadcast in response to a touch point of an input being at a display edge of a user interface (UI) of the second computing device;
receive an input confirming a location of the first computing device;
broadcast a second beacon;
receive, from the second computing device, content previously displayed on the UI of the second computing device; and
present, on a UI of the first computing device, the received content at a display edge of the UI of the first computing device proximate to the display edge of the UI of the second computing device.

19. The computer-readable medium of claim 18, wherein:
the display edge of the UI of the second computing device includes a first y-coordinate;
the display edge of the UI of the first computing device includes a second y-coordinate; and
the instructions further cause the processor to:
compute the second y-coordinate based on the first y-coordinate; and
present the received content at the display edge of the UI of the first computing device according to the computed second y-coordinate.

20. The computer-readable medium of claim 18, wherein:
the received input confirming the location of the UI of the first computing device further indicates a position at which the received content is to be displayed on the UI of the first computing device.
